(19) United States
(12) Patent Application Publication
(10) Pub. No.: US 2013/0151327 A1
(43) Pub. Date: Jun. 13, 2013

(54) Interactive Digital Rewards System and Method

(71) Applicant: Satyan Ranganath, Landenberg, PA (US)

(72) Inventor: Satyan Ranganath, Landenberg, PA (US)

(21) Appl. No.: 13/316,877

(22) Filed: Dec. 12, 2011

(51) Int. Cl. G06Q 30/02

(52) U.S. Cl. 705/14.33

(57) ABSTRACT

Embodiments of the invention are directed to an interactive rewards computing system for facilitating usage of rewards points for obtaining rewards. The system may include a computer memory storing a digital rewards magazine, the digital rewards magazine comprising a personalized introductory account page providing access to a number of rewards points available and multiple rewards available for the number of rewards points and multiple interactive reward pages. The multiple interactive rewards pages include rewards for purchase with rewards points, a reward description and at least one additional link containing reward information specific to the reward displayed on the reward page. The system may additionally include computer processing components accessing the computer memory and executing stored instructions for performing multiple steps.

### TECHNICAL FIELD

Embodiments of the invention are related to systems and methods for facilitating an interactive digital rewards experience.

### BACKGROUND OF THE INVENTION

While many banking customers now benefit through membership in a card rewards program, customer enjoyment of the programs is often limited due to limit access to rewards information and the difficulty of redeeming rewards directly from available information sources.

For example, while it is now commonplace to provide a magazine illustrating rewards and the point levels required to access the rewards, users typically do not have direct and automatic access to additional rewards information through the magazine. Additionally, the magazines themselves do not offer transactional capabilities through which users can redeem rewards.

A further difficulty with existing rewards interfaces is that merchants offering rewards do not have sufficient opportunity to advertise their rewards and target specific users. Thus, all users receive the same copy of the rewards magazine regardless of their interests or purchasing habits. Accordingly, users are required to explore the magazine in order to find items of interest, rather than having the items presented to them in a convenient manner.

Accordingly, currently existing scenarios for rewards presentation require considerable time and effort on the part of consumers. Furthermore, merchants participating in rewards programs have limited opportunity to appeal to a target audience. While various interfaces have been developed for allowing users to redeem rewards online, these interfaces are limited to searchable interfaces available through user account pages that allow users to search for specific items of interest. Once users locate the items of interest, such as a particular reward, limited information is available through the interface about the particular reward.

Further, from the standpoint of merchants, merchant funded offers such as those available through coupon sponsors such as Groupon™ or Living Social™ have limited beneficial value to merchants. For these offers, consumers purchase the offers through the coupon sponsor. The coupon sponsor keeps the money until the consumer actually visits the merchant and uses the coupon to make a purchase. At that point, the coupon sponsor gives half of the money to the merchant. This scenario has limited benefit to merchants. They typically do not receive the repeat customers expected and further they may lose money when customers do not redeem the purchased coupons. Furthermore, consumers are often dissatisfied because they are required to print a coupon and physically take it to a merchant location in order to utilize it.

Accordingly, a solution is needed for improving delivery of rewards information to allow merchant participation and facilitate ease of use for account holders or consumers. A solution is particularly needed for users of digital devices that provides a level of interactivity for both account holders and merchants. such that merchants are able to target users and account holders are able to easily locate valuable rewards information.

### SUMMARY OF THE INVENTION

In one aspect of the invention, an interactive rewards computing system is provided for facilitating usage of rewards points for obtaining rewards such as products or services. The system includes a computer memory storing a digital rewards magazine, the digital rewards magazine including a personalized introductory account page providing access to a number of rewards points available and multiple rewards available for the number of rewards points. The page may be personalized for each individual account holder as will be further described below. The digital rewards magazine further includes multiple interactive reward pages including rewards for purchase with rewards points, the reward pages including a reward description and at least one additional link containing reward information specific to the reward displayed on the reward page. The system additionally includes computer processing components accessing the computer memory and executing stored instructions for performing steps including updating the digital rewards magazine including the multiple interactive reward pages and the introductory account page implementing a magazine maintenance engine. Updating the multiple interactive product pages includes adding or deleting reward pages and updating the introductory account page includes updating points and accessible rewards. The system additionally processes transaction requests to purchase rewards from the multiple reward pages of the digital rewards magazine.

In another aspect of the invention, a computer-implemented interactive rewards method is provided for facilitating usage of rewards points for obtaining rewards. The method comprises storing a digital rewards magazine in a computer memory. The digital rewards magazine includes a personalized introductory account page providing access to a number of rewards points available and multiple rewards available for the number of rewards points, and multiple interactive reward pages including rewards for purchase with rewards points, the reward pages including a reward description and at least one additional link containing reward information specific to the reward displayed on the reward page. The method additionally includes accessing the digital rewards magazine and instructions stored in the computer memory and executing stored instructions for performing various steps. The steps include updating the digital rewards magazine including the multiple interactive reward pages and the introductory account page implementing a magazine maintenance engine, wherein updating the multiple interactive product pages includes adding or deleting reward pages and updating the introductory account page includes updating points and accessible rewards. The steps may additionally include processing requests to purchase goods or services from the multiple reward pages of the digital rewards magazine implementing a transaction processing engine.

In a further aspect of the invention, an interactive rewards computing system is provided for facilitating usage of rewards points for obtaining rewards. The system comprises a computer memory storing instructions and a digital rewards magazine, the digital rewards magazine comprising a personalized introductory account page providing access to a number of rewards points available and multiple rewards available for the number of rewards points. The system additionally comprises computer processing components accessing the computer memory and executing stored instructions for performing steps including, detecting a system user log in to the personalized introductory account and providing a merchant interface for allowing a merchant to make an offer to the system user, wherein the offer includes merchant funded rewards points in exchange for a purchase from the merchant by the system user. The steps may additionally include generating notification of a merchant funded reward offer to the system user based on information entered through the merchant interface, receiving notification of reward redemption of the merchant funded reward offer, and updating the personalized introductory account page to reflect an updated number of rewards points.

In a further aspect of the invention, an interactive rewards computing method is provided for facilitating usage of rewards points for obtaining rewards. The method includes storing instructions and a digital rewards magazine in a computer memory. The digital rewards magazine includes a personalized introductory account page providing access to a number of rewards points available and multiple rewards available for the number of rewards points. The method additionally includes accessing the digital rewards magazine and instructions stored in the computer memory and executing stored instructions using computer processing components for performing steps including detecting a system user log in to the personalized introductory account page and providing a merchant interface for allowing a merchant to make an offer to the system user, wherein the offer includes merchant funded rewards points in exchange for a purchase from the merchant by the system user. The method further includes generating notification of a merchant funded reward offer to the system user based on information entered through the merchant interface, receiving notification of reward redemption of the merchant funded reward offer, and updating the personalized introductory account page to reflect an updated number of rewards points.

### BRIEF DESCRIPTION OF THE DRAWINGS

The present invention is described in detail below with reference to the attached drawings figures, wherein:

FIG. 1 is a block diagram illustrating an operating environment for an interactive rewards computing system and method in accordance with an embodiment of the invention;

FIG. 2 is a block diagram illustrating components of the interactive rewards computing system in accordance with an embodiment of the invention;

FIG. 3 is a block diagram illustrating a digital rewards magazine implemented in the interactive rewards computing system in accordance with an embodiment of the invention;

FIG. 4A is a screen view illustrating information shown on a personal account screen of the interactive rewards computing system in accordance with an embodiment of the invention;

FIG. 4B is a screen view illustrating rewards magazine pages in accordance with embodiments of the invention;

FIG. 5 is a screen view illustrating an interactive product page from the digital rewards magazine in conjunction with embodiments of the invention;

FIG. 6 is a flow chart illustrating a method for interacting with a merchant for providing merchant funded rewards within the interactive rewards computing system in accordance with an embodiment of the invention;

FIG. 7 is a flow chart illustrating a method for interacting with a user within the interactive rewards computing system in accordance with an embodiment of the invention; and

FIG. 8 is a view illustrating a digital library for accessing the interactive rewards computing system in accordance with an embodiment of the invention.

### DETAILED DESCRIPTION OF PREFERRED EMBODIMENTS

Embodiments of the present invention are directed to an interactive rewards computing method and system for facilitating rewards usage by account holders, also referenced herein as “users”, “consumers”, and “customers”, using the system The system. enables account holders to redeem awards points and obtain rewards with minimal effort from any location.

Embodiments of the invention are directed to provision of a digital version of a rewards magazine that is provided to users of digital devices. The digital devices may include for example, handheld devices such as iPhones™ or iPads™, or larger display type devices including computing devices, preferably having touch screens such as the iWall™. The digital magazine provides a level of interactivity and touch that email and print versions of magazines cannot provide. In embodiments of the invention, the system provides users with a personalized experience, such that users can interact with the digital rewards magazine while logged into their rewards accounts.

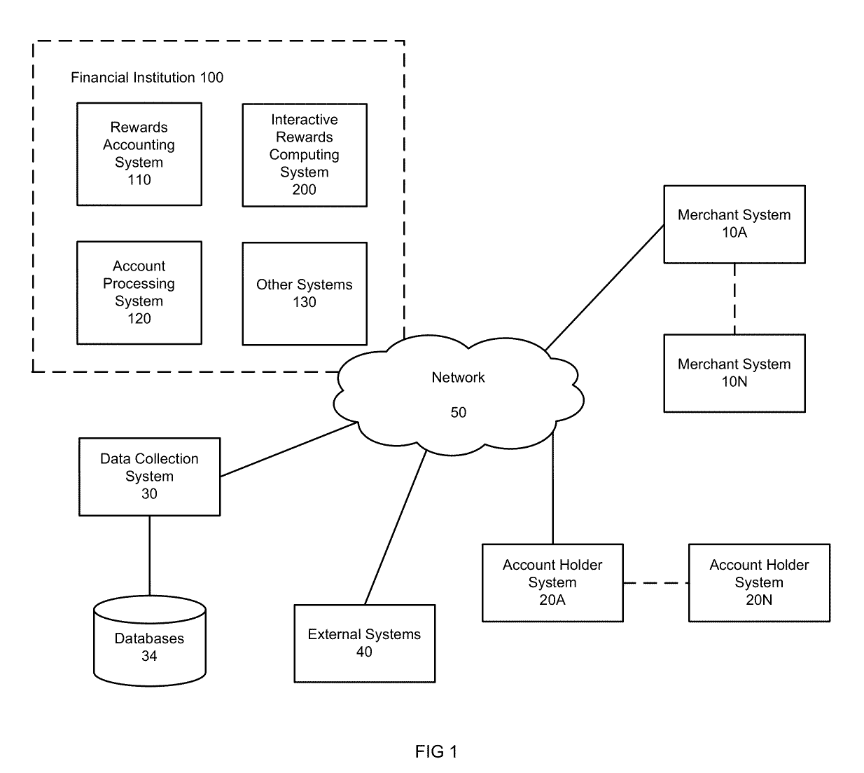

FIG. 1 is a block diagram illustrating an operating environment for an interactive rewards computing system and method in accordance with an embodiment of the invention. Entities including merchants 10a . . . 10n, account holders 20a . . . 20n, data collection system 30, databases 34, external systems 40 and financial institution 100 may be connected to one another over a network 10.

The financial institution 100 may include various systems, such as a rewards accounting system 110, a card or account processing system 120, other systems 130 and an interactive rewards computing system 200. The rewards accounting system 110 may be or include a system having functionality known in the art for tracking rewards accumulated and expended by account holders. The card or account processing system 120 may possess functionality known in the art for processing credit card or other account transactions and updating account data. For example, the account processing systems 120 may process transactions for debit, credit, checking, or savings accounts. As known in the art, financial institutions may integrate or connect with multiple other types of systems 130.

The interactive rewards computing system 200 communicates with the aforementioned systems integrated with or in communication with the financial institution 100 and facilitates rewards transactions for both consumers and merchants as will be more fully described below with reference to the remaining figures. The interactive rewards computing system 200 can implement computer hardware and software specifically designed for the delivery of cloud services, including multi-core processors, cloud-specific operating systems and combined offerings. Cloud computing provides computation, software, data access, and storage services that do not require end-user knowledge of the physical location and configuration of the system that delivers the services. This implementation of the cloud computing concept provides a technique for increasing capacity investing in new infrastructure or training new personnel.

The merchants 10a . . . 10n may be linked to the financial institution 100 via computing devices over the network 50. The merchants 10 may be linked to Point of Sale (POS) devices that transmit purchase information. POS terminals may be disposed at the location where a transaction occurs. A POS terminal may refer to the hardware and software used for checkouts. A retail POS system typically includes a computer, monitor, cash drawer, receipt printer, user display and a barcode scanner, and a debit/credit card reader. It can also include a weight scale, integrated credit card processing system, a signature capture device and a user pin pad device. Many POS monitors use touch-screen technology for ease of use and a computer is built in to the monitor chassis for what is referred to as an all-in-one unit. A device such as an iWall may be included as the POS system. The POS system software can typically handle a myriad of user based functions such as sales, returns, exchanges, layaways, gift cards, gift registries, user loyalty programs, and quantity discounts.

In embodiments of the invention, the interactive rewards computing system 200 may be utilized to partner with the merchant systems 10. As will be further described below, rewards typically provided by financial institution 100 may be funded through merchants 10.

The account holders 20a . . . 20n preferably have access to the interactive rewards system 200 over the network 50 through a plurality of connected devices. It should be understood and the type and number of connected devices may be virtually unlimited and may encompass both private devices and public devices, to which the users do not have exclusive access. Thus, the account holder environment may include mobile devices, home devices, office devices, and public devices.

Mobile devices may include various known mobile computing devices, which also may be referenced as handheld devices, handheld computers or simply handhelds. These may be pocket-sized computing devices, typically having a display screen with touch input and/or a miniature keyboard. In the case of the personal digital assistant (PDA), the input and output are often combined into a touch-screen interface. The mobile devices may also be or include iPhones, iPads, net books, E-readers, tablet computers or other devices. Typically these devices are also equipped with cameras or other imaging devices. Home devices and office devices may include any standard computing equipment implemented in homes and offices. Additionally, users may implement more sophisticated computing equipment to obtain the full benefit of the interactive rewards experience offered through the system. For example, users may implement large touch screens, motion sensing equipment, voice recognition units (VRUs), or other technologies.

Public devices may include any publicly available computing devices, such as large touch screens available, for example, in hotel lobbies and train stations. In preferred embodiments of the invention, users will be able to customize to enable different modes for public computing equipment and private computing equipment.

The data collection system 30, although shown as external to the financial institution 100, may be connected with or internal to the financial institution systems 100, to external merchant systems 10, or to other external systems 40. The data collection system 30 may collect data pertaining to user purchasing and/or browsing behaviors and store the data in databases 34. The databases 34 may store information pertaining to the account holders or users. The information may include, for example, demographic information, account data, purchasing behaviors, or other information.

The external systems 40 may be or include any other systems providing information to the financial institution system 100, merchant systems 10 or account holder systems 20.

The network 50 may the Internet, an Intranet, Extranet, Ethernet, or any other system that provides communications. Some suitable communications protocols may include TCP/IP, UDP, or OSI for example. For wireless communications, communications protocols may include Bluetooth, Zigbee, IrDa or other suitable protocol. Furthermore, components of the system may communicate through a combination of wired or wireless paths. Wireless data connections used in mobile computing may take a multiple forms. Cellular data service uses technologies including such as 3G networks and 4G networks. These networks are usually available within range of commercial cell towers. Wi-Fi connections may offer higher performance, but have limited range, Some enterprise deployments combine networks from multiple cellular networks or use a mix of cellular, Wi-Fi and satellite. Although one network is shown, a larger number of networks may be provided. All of the system components may communicate over a single network, such as the Internet, or over multiple networks, with the interactive rewards computing system 200.

The network 50 may in some instances be a private Wi-Fi network offered by the financial institution 100. Such a network may be offered in situations in which a user has no internet access, such as when commuting on a plane, train, bus, or other vehicle. The network may also be provided with increased bandwidth or encryption in instances in which internet access is available. The delivery of the content described herein may be tailored such that account holders are provided with incentives to access and use rewards points to make purchases. Furthermore, the vehicle, for example an airline, may be partnered with the financial institution and may provide a reward, such as a free cocktail, for use of and time spent on the Wi-Fi network 50. The financial institution 100 may alternatively or also provide additional rewards points for time spent on the Wi-Fi network. The content provided may include content additional to the rewards magazine content, such as games and surveys provided and processed by the financial institution 100 for the benefit of program development by the financial institution 100 and/or the vehicle partner.

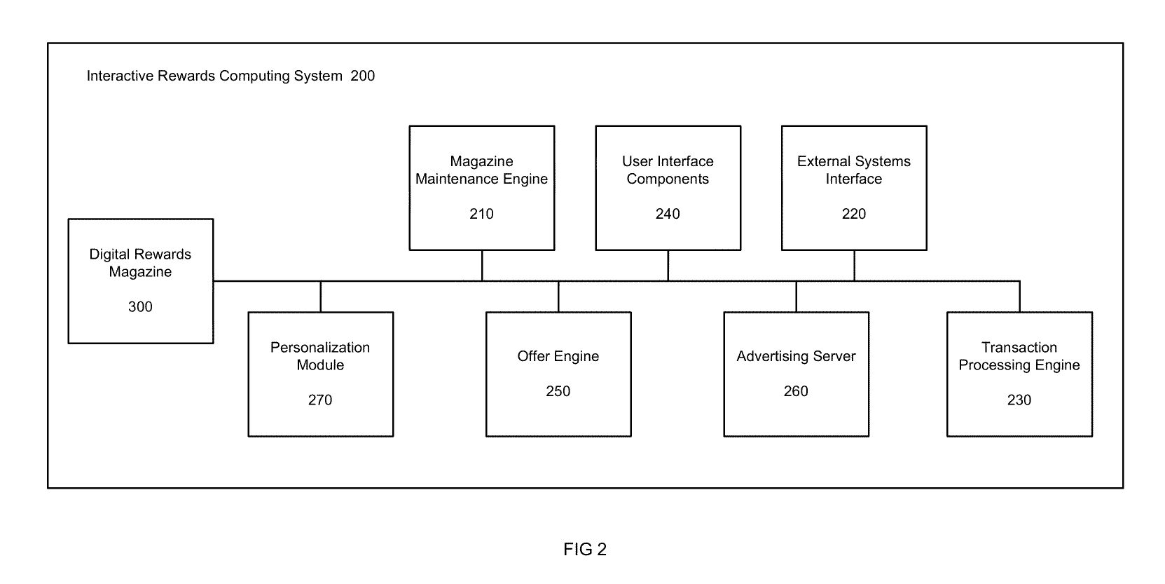

FIG. 2 is a block diagram illustrating components of an interactive rewards computing system 200 in accordance with an embodiment of the invention. The interactive rewards computing system 200 may include computing components such as a processor and a memory. These components are further described below. The processor may access and execute instructions stored in the memory in order to perform various method steps in accordance with embodiments of the invention. The instructions may be stored as engines, modules, components, which may be executed to facilitate interaction and transform information. Additionally, within the interactive rewards computing system 200, multiple distributed computing systems, servers, other hardware devices may be connected. While the computer processing components and computer memory are not shown separately, their functionality is integrated with the components shown and they are fully described herein.

As illustrated in FIG. 2, the interactive rewards computing system 200 may include a digital rewards magazine 300. Various systems and components may interact to create, maintain, and operate the digital rewards magazine. As illustrated, a magazine maintenance engine 210, an external systems interface 220, a transaction processing engine 230, user interface components 240, an offer engine 250, an advertising server 260, and a personalization module 270 may be provided. It should be understood that although these components are shown as separate components communicating with one another, they may also be integrated with one another.

The digital rewards magazine 300 preferably includes multiple pages that may be accessed consecutively or by numeric selection. In embodiments of the invention in which an interactive touch screen display is implemented, users may physically turn pages of the digital rewards magazine 300. The digital rewards magazine preferably includes products, services, or other rewards accessible in exchange for rewards points. The digital rewards magazine 300 preferably includes deep linking, or the provision of hyperlinks that point to a specific page or image within the UR magazine rather the main cover page. Thus, if the user selects a proposed reward, the user will be directed to an interface for that reward. The reward may for example be a vacation and further links may lead to an interactive map of the Virgin Islands and may further include videos. For concert tickets, links may lead to music recordings. For other products, links may be provided that lead to product information, demos, reviews, or other valuable information. In instances in which the user cannot or does not want to use rewards points to pay for a displayed product, the user can be provided with the option to purchase the product through a displayed link.

The improved functionality is particularly apparent with the user of digital devices. These devices may include for example, handheld devices such as iPhones™ or iPads™, or larger display type devices including computing devices, preferably having touch screens such as the iWall™. Technology such as the multi-touch displays created by Perceptive Pixel™ may also be incorporated. The digital magazine provides a level of interactivity and touch that email and print versions cannot provide. For example, the digital version allows interaction with images and videos that are often filtered by email. Users can flip pages and move back and forth within a page.

The magazine maintenance engine 210 may provide updates to the rewards magazine on a periodic basis, such as daily, weekly, monthly, or quarterly. Updates are preferably performed automatically, such that the cover of the magazine and its contents change periodically.

The external systems interface 220, may accept input and send output to external systems that operate cooperatively with the interactive rewards computing system 200. As set forth respect to FIG. 1, the external systems may include merchant systems, banking systems such as account processing systems, databases, fraud monitoring systems and any other systems capable of communication with the interactive rewards computing system 200.

The transaction processing engine 230 may implement processing capabilities in order to process transactions on behalf of account holders. For example, account holders may select one or more links and/or enter information in order to exchange rewards points for displayed rewards. The transaction processing engine 230 facilitates the transactions and forwards information such that the reward is ultimately received by the account holder and the rewards account information for the account holder is updated. In embodiments of the invention, the transaction processing engine 230 may be able to facilitate exchange of gift certificates, other types of points, or actual currency for purchase of rewards. This capability may depend on the type of account (e.g. small business, high net worth, personal, etc.) held by the account holder or on the reward desired.

The user interface components 240 may provide the user with the visual tools to experience the magazine and may further operate to process user input in order to conduct transactions. The input may take various forms and preferably includes tactile or touch input and voice input. The input may also be keyboard input, motion input, and for the purpose of security monitoring, may include retinal input or thumbprint input. The user interface components 240 are operational to sense any input that may be provided from user interface tools on any devices connected within each user system. As used herein, the user interface components 240 may includes any hardware, software, or combination of hardware and software used by the processing machine that allows a user to interact with the computer processor or processing machine.

User interfaces may vary depending on the nature of the viewing device. For example, on a large touch screen such as the iWall, the user can be viewing multiple windows or sections including, for example streaming news, different magazines, etc. However, for the purposes of transactions with the rewards magazines, the user may open the magazine and see product selections. If the iWall is a public device, the user may need be required to securely log in. Different versions of the magazine, including different personalized introductory pages may be presented depending on the account the user selects. Alternatively, multiple magazine interfaces may be displayed for multiple accounts.

The offer engine 250 generates offers for system users. The offer engine 250 may include a pre-existing component of a financial institution that provides offers based on monitored user behavior. For example, users may engage in various purchasing activities or account activities that cause offers to be generated. In the context of rewards, the offer engine 250 may be modified in order to make personalized rewards offers to account holders. In embodiments of the invention, these offers may include merchant funded rewards points. Such offers may include, for example, providing the account holder with a chance to purchase goods or services from the merchant and receive triple rewards points (or any pre-set number of rewards points) for making the purchase. A purchase amount threshold may be set. For example, the merchant may offer triple rewards points for purchases over fifty dollars. In addition to personalizing the offers based on user behavior, the offer engine 250 may personalize the offer based on the location of the device or system used to access the rewards magazine. For example, if the user logs onto his account at a public terminal in a train station, the offer engine 250 may be preconfigured to make offers from merchants located within the train station. Furthermore, the offer engine 250 may make offers based on time of day. Offers from coffee houses may be made in the morning. Offers from pubs may be generated in the evening.

Thus, in embodiments of the invention, advertisements and offers displayed in connection with the rewards magazine may relate to merchant funded offers, wherein the merchants fund their offers with rewards points. For example, after assessing user purchasing behavior, the system may determine that the user regularly purchases athletic equipment and, at the request of the merchant, may advise the user that Sports Authority will give him ten times his usual rewards points if the user spends at least thirty dollars (or any predetermined amount) at the Sports Authority. The expenditure can occur over the internet or in person without printing out coupons or other information. Once the expenditure occurs, the user's rewards account is credited with the points.

The advertising server 260 may operate separately from the offer engine to provide advertisements based on prior user purchasing behaviors as well as user viewing behavior on the rewards magazine. Public systems may log and recognize users that have visited the system before and may advertise based on activities during previous visits. The larger public device may also provide advertisements and reward suggestions that are both location and time specific. For example, if the public device is in an airport, the advertisements may incorporate shops and restaurants within the airport. If it's 8 AM, the advertisements may be breakfast advertisements. If it's 8 PM, the advertisements may be for bars within the airport. The location and time specific ads may also be displayed on personal digital devices. In this embodiment, the user may input a location or the location may be ascertained by GPS.

The personalization module 270 may personalize the rewards magazine 300 for the account holder. In order to personalize, the system must first determine the identity of the account holder. Authentication procedures may be required in order to generate a personalized experience. The system may prompt users to enter credentials upon an attempt to log in to a rewards account. Credentials may be entered in various ways dependent upon the particular device or user interface provided. For example, an account holder interacting with a device having image recognition capabilities may show the device a visual representation of a rewards code, for example on a phone. Alternatively, credentials may be entered through touch. In embodiments of the invention, the system may discern the difference between different people with the same accounts, for example, family members. This could be accomplished through biometric or other sensing capabilities. The system may be able to filter content inappropriate for children and tailor content to the specific account holder interacting with the system. The personalization module 270 may gather required information from databases and incorporate that information for use by other systems and components, such as the magazine maintenance engine, advertising server, and the offer engine.

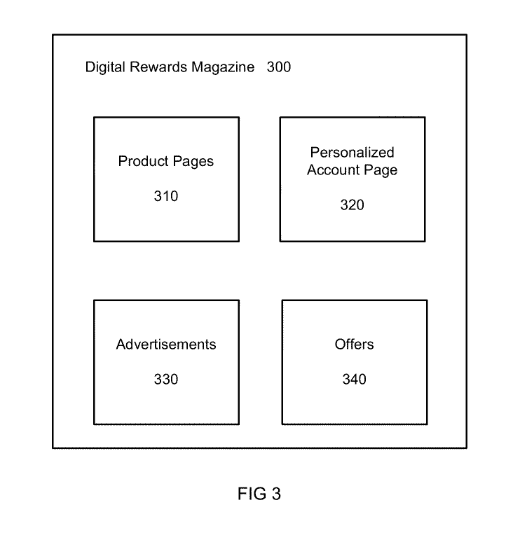

FIG. 3 is a block diagram illustrating a digital rewards magazine implemented in the interactive rewards computing system in accordance with an embodiment of the invention. The digital rewards magazine 300 may include a cover page 305, product pages 310, a personalized account page 320, advertisements 330, and offers 340.

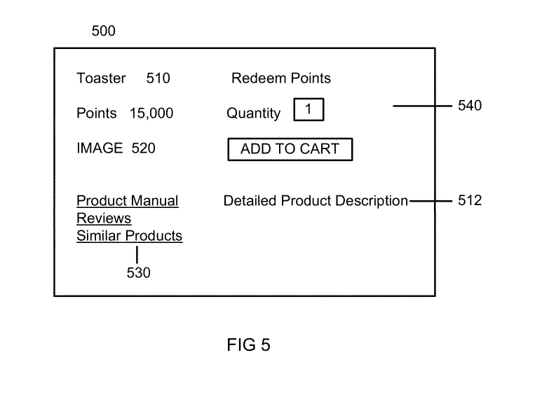

The cover page 305 may be or include a rendering of the rewards magazine cover, which may feature a particular product or set of products, or alternatively a sale or special event. Product pages 310 preferably include descriptions of products along with the number of rewards points required to purchase the product. The magazine 300 is primarily composed from these product pages 310. In preferred embodiments, account holders are able to flip from one product page to another and select links provided on the product pages in order to acquire more information about the products. Product pages are further described below with reference to FIG. 5

The personalized account page 320 is provided to account holders recognized by the system. Account holders may be provided with a personalized experience, such that they can interact with the digital rewards magazine while logged into their accounts. Thus, the system can provide the account holder with a number of available rewards points and a number of projected rewards points during a specified time period. The system may provide an interface introducing the rewards the user can afford today as well as rewards the user might be able to afford by the end of the year.

While interaction on a user's personal digital device is easily personalized, users can also receive a personalized experience on a public device such as a touch screen in a hotel, airport, train station, or merchant location. The public rewards magazine process may require enhanced login credentials. In embodiments of the invention, the user may login through communication between his personal digital device and the larger public device. The user may implement mobile wallet features to touch the wall and buy products.

The advertisements 330 are generated by the advertising server described above and may be displayed on the product pages, or as pop-ups on a separate portion of the device. Alternatively, advertisements may be generated in entirely audio form and may be automatically generated by the advertising server when specific pages of the rewards magazine are accessed.

The offers 340 are generated through the offer engine described above. As set forth with respect to advertisements, offers may be provided on product pages or may be generated as pop-ups. Alternatively offers may be generated in audio form when users access a particular product page or their accounts.

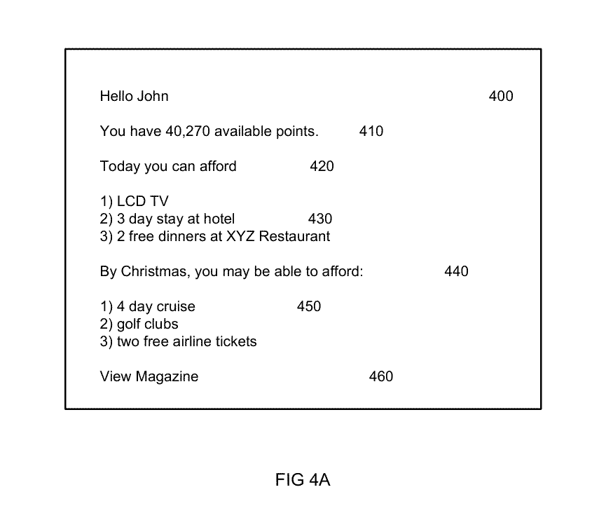

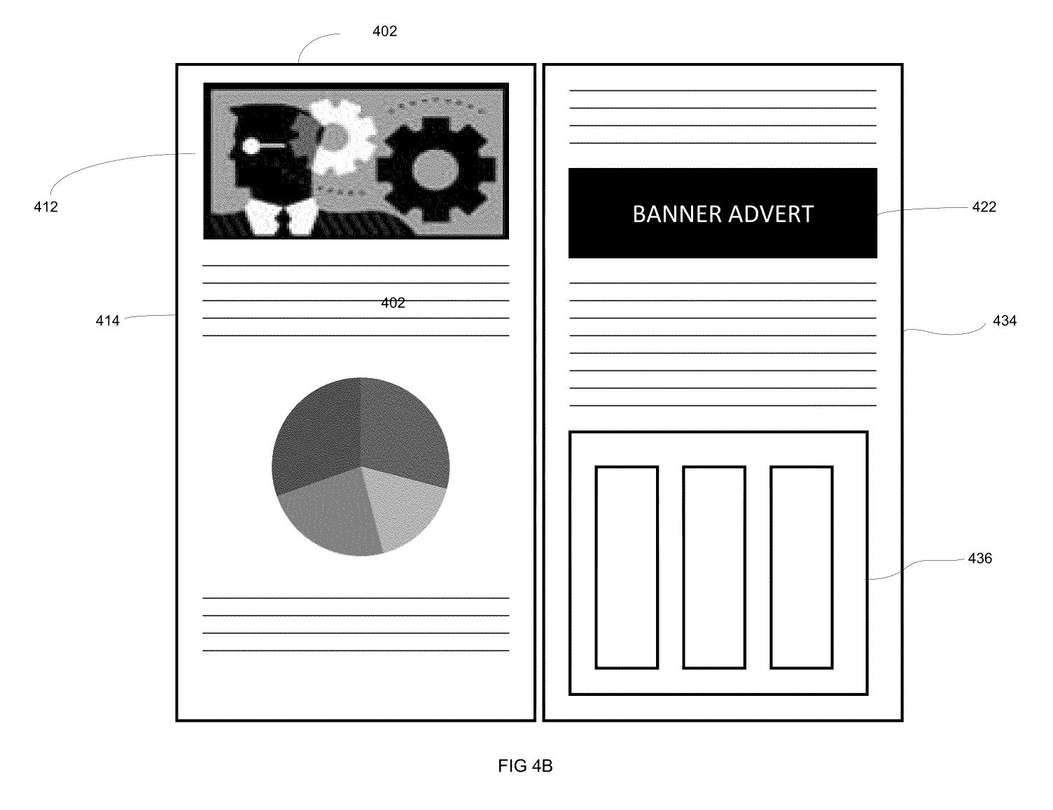

FIG. 4A is a screen view illustrating information shown on a personal account screen 400 of the rewards magazine of the interactive rewards computing system in accordance with an embodiment of the invention A greeting 410 may greet the user and provide a number of available points. The screen 400 may further provide a section 420 indicating specific rewards 430 that the user can currently afford. In the illustrated example, the user can currently afford an LCD TV, a three night hotel stay, or two free dinners at a featured restaurant. An additional section 440 may display, in accordance with a user's spending habits, rewards selections that a user may be able to afford in the future. In the illustrated example, the system predicts that the user can afford, by Christmas, rewards 450 including a four day cruise, golf clubs, or two free airline tickets. If the user opts to access the product pages without selecting any of the displayed rewards, the user may select a view magazine link 460.

In preferred embodiments of the invention, the user may be able to select, by clicking, touching, speaking, gesturing, facial recognition, other biometric sensing, or other method, any of the displayed rewards. The selection may lead the user to a product page providing further details about the selected reward.

FIG. 4B is a screen view illustrating rewards magazine pages 402 in accordance with embodiments of the invention. Graphics 412 may be provided for descriptive content along with written descriptions 414 and pie charts 442. An advertisement 432 may be provided and may be personalized to the particular account holder accessing the magazine pages 402. Further descriptive content 434 and visuals such as bar graphs 436 may be provided.

FIG. 5 is a screen view illustrating an interactive product page 500 from the digital rewards magazine in conjunction with embodiments of the invention. The product page 500 may include the name of the product 510, preferably accompanied by an image 520. Adjacent the name and/or image, a number of rewards points required to obtain the product or reward may be shown. Selectable links 530 may display information such as a product manual, reviews, or similar products. Detailed product information 512 may also be provided. A shopping cart feature 540 may allow the user to redeem rewards points by adding one or more of the displayed product to a shopping cart.

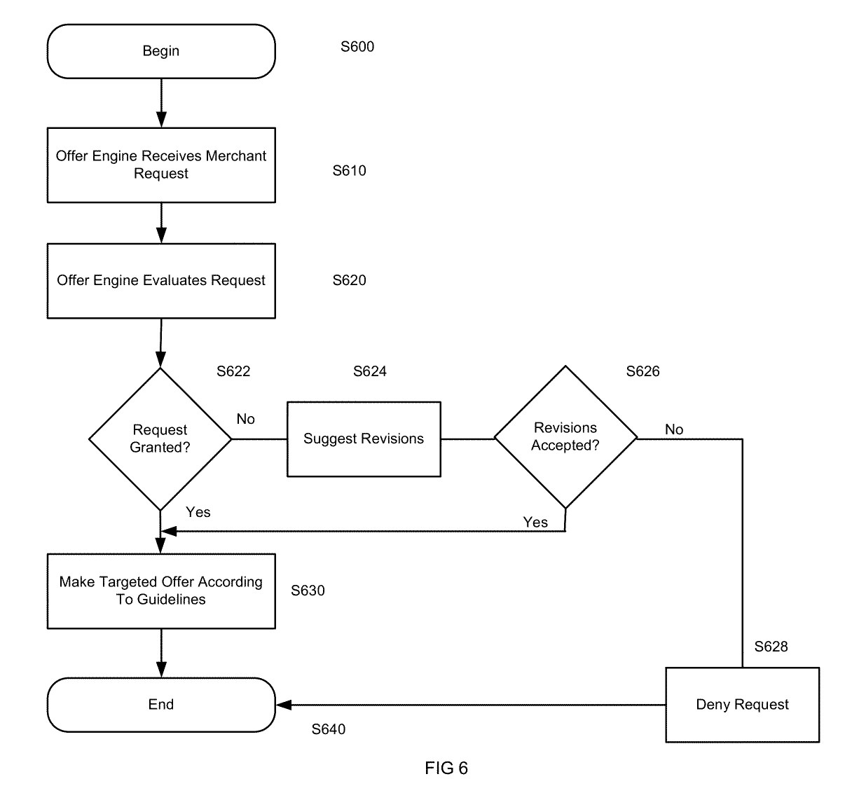

FIG. 6 is a flow chart illustrating a method for interacting with a merchant for providing merchant funded rewards within the interactive rewards computing system in accordance with an embodiment of the invention. The method begins in S600 and the offer engine receives a merchant request in S610. The merchant may request, for example, the display of an offer for triple rewards points if the user spends thirty dollars or more at the merchant store. The offer engine evaluates the merchant request in S620 to determine if the offer complies with system requirements. The offer engine may further make arrangements for merchant funding during evaluation of the request. If the request is granted in S622, the offer engine may create the targeted offer in accordance with system guidelines in S630 and the process may end in S640. If the merchant request is not granted in S622, the system may suggest revisions in S624. For example, the system may determine that the merchant proposed spending threshold is too high or not high enough and suggest another threshold. The system may alternatively determine that the rewards points offered are not high enough for the offer to be displayed. If the merchant accepts proposed revision in S626, the offer engine will make the targeted offer in S630. If the merchant does not accept the revisions in S626, the offer engine will deny the request in S628 and the process will end in S640.

Once the offer is provided to the account holder, the account holder may go directly to the merchant to make a purchase. Purchase authorization may arrive at the financial institution, which matches the credits with points. The interactive rewards system 200 can then provide the merchant with a communication that indicates that providing a targeted offer to a particular account holder created a revenue stream.

In preferred embodiments, rather than funding coupons or discounts, merchants actually fund rewards points. In most systems, points cost merchants merely a fraction of what a typical merchant funded offer would cost. The disclosed system can, based on prior purchasing behaviors, provide a targeted offer that is extremely likely to create business for the merchant. For example, if the system determines that the system user purchases a beer multiple times a week between six and 8 PM on Clark Street, merchants on Clark Street will likely provide an offer to entice the user. Offers may include a spending threshold, for example ten dollars, or thirty dollars, or fifty dollars before the rewards points will be provided. For account holders, these rewards are beneficial as they provide additional value for items that the consumer habitually purchases. Furthermore, consumers do not need coupons or printouts as they need with current merchant funded offer systems.

Value is also generated for the merchant and for the financial institution holding the credit account Although the example above illustrates the merchant obtaining approval from the financial institution for generated offers, in embodiments of the invention, the offers may be completely customized and controlled by merchant and merchant can set the rules. The merchant may immediately be showcased on millions of consumers mobile phones. The system may include an on-boarding tool where the merchants create an offer that allows them to become featured in this manner and become featured. The merchant relationship or account with the financial institution may impact the merchant's chance of being a featured merchant.

The financial institution also benefits from the system in multiple ways. The financial institution may generated more card accounts, increased out of wallet spending, and obtain more exposure to the rewards marketplace.

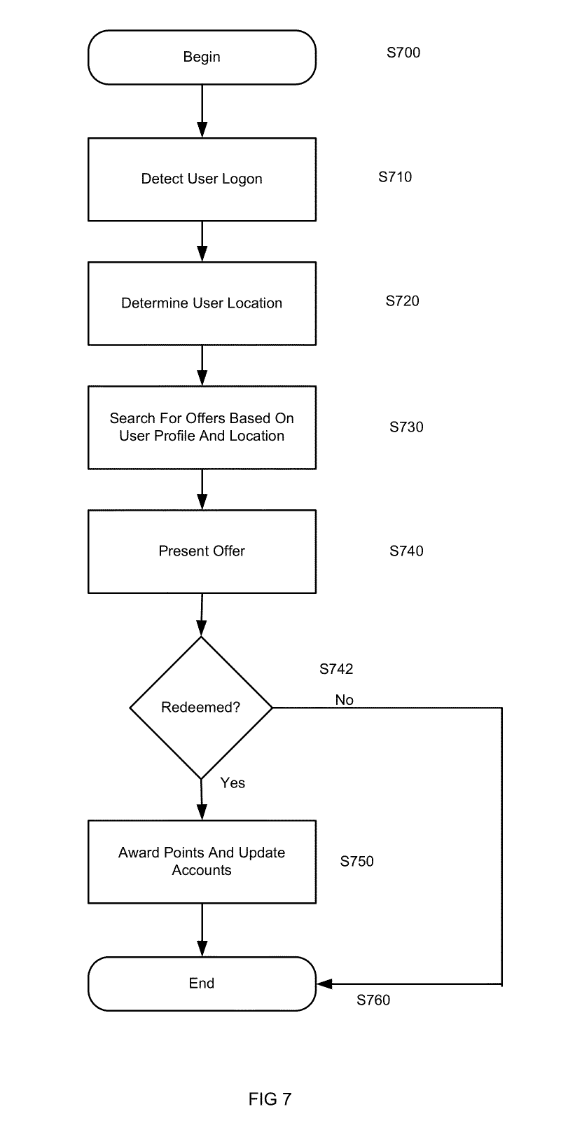

FIG. 7 is a flow chart illustrating a method for interacting with a user within the interactive rewards computing system in accordance with an embodiment of the invention. The method begins in S700 and the system detects the user login in S710. In S720, the system may determine a user location. In S730, the system may search for stored offers based on the user profile and user location. In S740, the system may present a selected offer. If the offer is redeemed in S740, the system may award points and update the user account in S750. The process ends in S760.

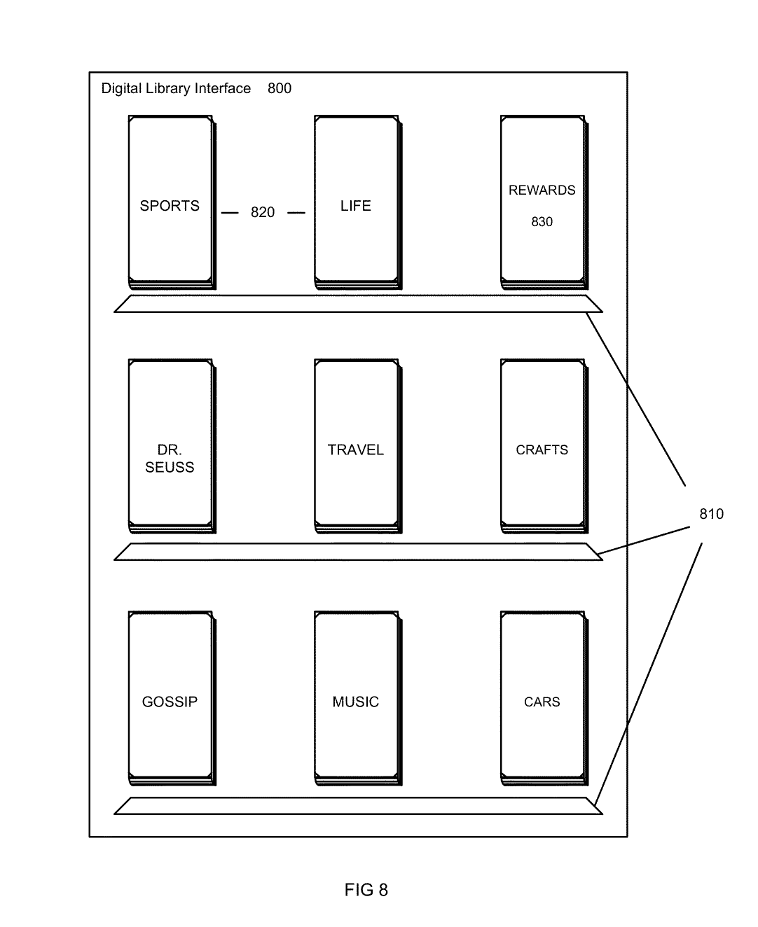

FIG. 8 is a view illustrating a digital library for accessing the interactive rewards computing system in accordance with an embodiment of the invention. A library interface 800 may include multiple periodicals 820 on multiple shelves 810. The periodicals may include the above-described rewards magazine 830. The periodicals 820 including the rewards magazine 830 may be available through digital subscription. Accordingly, the rewards magazine 830 may be available through the duration of a user subscription. Subscriptions may be, for example, monthly, quarterly, or annually.

An exemplary system is the “newsstand” managed by Apple. Newstand offers subscriptions quarterly or monthly newspapers, magazines, or catalogs. The rewards magazine may be available via Newstand. Accordingly existing rewards magazine frameworks can be converted to digital and published to Newsstand. Similar libraries may be provided by Amazon™, Barnes™ and Noble™, and other entities, and may be utilized in accordance with embodiments of the invention.

The system of the invention or portions of the system of the invention may be in the form of a “processing machine,” i.e. a tangibly embodied machine, such as a general purpose computer or a special purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as any of the processing as described herein. Such a set of instructions for performing a particular task may be characterized as a program, software program, or simply software.

As noted above, the processing machine, which may be constituted, for example, by the particular system and/or systems described above, executes the instructions that are stored in the memory or memories to process data. This processing of data may be in response to commands by a user or users of the processing machine, in response to previous processing, in response to a request by another processing machine and/or any other input, for example. As noted above, the processing machine used to implement the invention may be a general purpose computer. However, the processing machine described above may also utilize (or be in the form of) any of a wide variety of other technologies including a special purpose computer, a computer system including a microcomputer, mini-computer or mainframe for example, a programmed microprocessor, a micro-controller, a peripheral integrated circuit element, a CSIC (Consumer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the invention.

The processing machine used to implement the invention may utilize a suitable operating system. Thus, embodiments of the invention may include a processing machine running the Microsoft Windows™ Vista™ operating system, the Microsoft Windows™ XP™ operating system, the Microsoft Windows™ NT™ operating system, the Windows™ 2000 operating system, the Unix operating system, the Linux operating system, the Xenix operating system, the IBM AIX™ operating system, the Hewlett-Packard UX™ operating system, the Novell Netware™ operating system, the Sun Microsystems Solaris™ operating system, the OS/2™ operating system, the BeOS™ operating system, the Macintosh operating system, the Apache operating system, an OpenStep™ operating system or another operating system or platform.

It is appreciated that in order to practice the method of the invention as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing as described above is performed by various components and various memories. However, it is appreciated that the processing performed by two distinct components as described above may, in accordance with a further embodiment of the invention, be performed by a single component. Further, the processing performed by one distinct component as described above may be performed by two distinct components. In a similar manner, the memory storage performed by two distinct memory portions as described above may, in accordance with a further embodiment of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity; i.e., so as to obtain further instructions or to access and use remote memory stores, for example. Such technologies used to provide such communication might include a network, the Internet, Intranet, Extranet, LAN, an Ethernet, or any client server system that provides communication, for example. Such communications technologies may use any suitable protocol such as TCP/IP, UDP, or OSI, for example.

As described above, a set of instructions is used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object oriented programming. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments of the invention. Illustratively, the programming language used may include assembly language, Ada, APL, Basic, C, C++, COBOL, dBase, Forth, Fortran, Java, Modula-2, Pascal, Prolog, REXX, Visual Basic, and/or JavaScript, for example. Further, it is not necessary that a single type of instructions or single programming language be utilized in conjunction with the operation of the system and method of the invention. Rather, any number of different programming languages may be utilized as is necessary or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, a EPROM, a wire, a cable, a fiber, communications channel, a satellite transmissions or other remote transmission, as well as any other medium or source of data that may be read by the processors of the invention.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, voice reader, voice recognizer, dialogue screen, menu box, list, checkbox, toggle switch, a pushbutton or any other device that allows a user to receive information regarding the operation of the processing machine as it processes a set of instructions and/or provide the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method of the invention, it is not necessary that a human user actually interact with a user interface used by the processing machine of the invention. Rather, it is also contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

It will be readily understood by those persons skilled in the art that the present invention is susceptible to broad utility and application. Many embodiments and adaptations of the present invention other than those herein described, as well as many variations, modifications and equivalent arrangements, will be apparent from or reasonably suggested by the present invention and foregoing description thereof, without departing from the substance or scope of the invention.

Accordingly, while the present invention has been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications and equivalent arrangements.

From the foregoing it will be seen that this invention is one well adapted to attain all the ends and objects set forth above, together with other advantages, which are obvious and inherent to the system and method. It will be understood that certain features and sub-combinations are of utility and may be employed without reference to other features and sub-combinations. This is contemplated and within the scope of the appended claims.

1. An interactive rewards computing system for facilitating usage of rewards points for obtaining rewards, the system comprising:
a computer memory storing a digital rewards magazine, the digital rewards magazine comprising;
a personalized introductory account page providing access to a number of rewards points available and multiple rewards available for the number of rewards points, and
multiple interactive reward pages including rewards for purchase with rewards points, the reward pages including a reward description and at least one additional link containing reward information specific to the reward displayed on the reward page; and
computer processing components accessing the computer memory and executing stored instructions for performing steps including;
updating the digital rewards magazine including the multiple interactive reward pages and the introductory account page implementing a magazine maintenance engine, wherein updating the multiple interactive product pages includes adding or deleting reward pages and updating the introductory account page includes updating points and accessible rewards; and
processing transaction requests to purchase rewards from the multiple reward pages of the digital rewards magazine.

2. The system of claim 1, wherein processing transaction requests to purchase rewards comprises accepting rewards points in exchange for a selected rewards

3. The system of claim 1, wherein the steps further comprise accessing stored information to determine characteristics of the system user including at least one of prior purchases and user residence location and personalizing an offer upon detecting access to the introductory account page.

4. The system of claim 1, wherein the steps further comprise determining a current time of day and location of the system user upon login and delivering a personalized advertisement based on the determination.

5. The system of claim 4, wherein the steps further comprise delivering an offer including merchant funded rewards points with the personalized advertisement.

6. The system of claim 1, wherein the personalized introductory account page includes multiple rewards selected based on stored user profile information.

7. The system of claim 6, wherein the personalized introductory account page further includes a projected number of rewards points available as of a future date and a set of rewards accessible to the user for the projected number of points.

8. The system of claim 1, wherein at least one of the multiple interactive reward pages includes a product reward with links to reward information including a product web site.

9. The system of claim 1, wherein at least one of the multiple interactive reward pages includes a vacation reward and at least one link to a map illustrating a vacation location.

10. The system of claim 1, wherein the multiple interactive rewards pages include an interface allowing the system user to flip to a next reward page or a previous reward page.

11. A computer-implemented interactive rewards method for facilitating usage of rewards points for obtaining rewards, the method comprising:
storing a digital rewards magazine in a computer memory, the digital rewards magazine comprising:
a personalized introductory account page providing access to a number of rewards points available and multiple rewards available for the number of rewards points, and
multiple interactive reward pages including rewards for purchase with rewards points, the reward pages including a reward description and at least one additional link containing reward information specific to the reward displayed on the reward page; and
accessing the digital rewards magazine and instructions stored in the computer memory computer memory;
executing stored instructions for performing steps including,
updating the digital rewards magazine including the multiple interactive reward pages and the introductory account page implementing a magazine maintenance engine; wherein updating the multiple interactive product pages includes adding or deleting reward pages and updating the introductory account page includes updating points and accessible rewards; and
processing requests to purchase rewards from the multiple reward pages of the digital rewards magazine implementing a transaction processing engine.

12. The method of claim 11, wherein processing requests to purchase rewards comprises accepting rewards points in exchange for a selected rewards.

13. The method of claim 11, further comprising accessing stored information to determine characteristics of the system user including at least one of prior purchases and user residence location and personalizing an offer upon detecting access to the introductory account page.

14. The method of claim 11, further comprising determining a current time of day and location of the system user upon login and delivering a personalized advertisement based on the determination.

15. The method of claim 14, further comprising delivering an offer including merchant funded rewards points with the personalized advertisement.

16. The method of claim 11, further comprising displaying multiple rewards selected based on stored user profile information on the personalized introductory account page.

17. The method of claim 16, further comprising including a projected number of rewards points available as of a future date and a set of rewards accessible to the user for the projected number of points on the personalized introductory account page.

18. The method of claim 11, further comprising providing a link to reward information including a product web site, wherein at least one of the multiple interactive reward pages includes a product reward.

19. The method of claim 11, further comprising providing at least one link to a map illustrating a vacation location, wherein at least one of the multiple interactive reward pages includes a vacation reward.

20. The method of claim 11, further comprising providing an interface on the multiple interactive rewards pages allowing the system user to flip to a next reward page or a previous reward page.

21. An interactive rewards computing system for facilitating usage of rewards points for obtaining rewards, the system comprising:
a computer memory storing instructions and a digital rewards magazine, the digital rewards magazine comprising a personalized introductory account page providing access to a number of rewards points available and multiple rewards available for the number of rewards points, and
computer processing components accessing the computer memory and executing stored instructions for performing steps including,
detecting a system user log in to the personalized introductory account;
providing a merchant interface for allowing a merchant to make an offer to the system user, wherein the offer includes merchant funded rewards points in exchange for a purchase from the merchant by the system user;
generating notification of a merchant funded reward offer to the system user based on information entered through the merchant interface;
receiving notification of reward redemption of the merchant funded reward offer; and
updating the personalized introductory account page to reflect an updated number of rewards points.

22. The system of claim 21, further comprising multiple interactive rewards pages including rewards for purchase with rewards points.

23. The system of claim 22, wherein the multiple interactive rewards pages further comprise at least a reward description and one additional link containing reward information specific to the reward displayed.

24. The system of claim 21, wherein the steps further include accessing stored information to determine characteristics of the system user including at least one of location and prior purchases and personalizing the offer upon access to the introductory account page.

25. The system of claim 24, wherein the steps further include determining a time of day and tailoring the offer based on the time of day.

26. An interactive rewards computing method for facilitating usage of rewards points for obtaining rewards, the system comprising:
storing instructions and a digital rewards magazine in a computer memory, the digital rewards magazine comprising a personalized introductory account page providing access to a number of rewards points available and multiple rewards available for the number of rewards points, and
accessing the digital rewards magazine and instructions stored in the computer memory;
executing stored instructions using computer processing components for performing steps including,
detecting a system user log in to the personalized introductory account page;
providing a merchant interface for allowing a merchant to make an offer to the system user, wherein the offer includes merchant funded rewards points in exchange for a purchase from the merchant by the system user;
generating notification of a merchant funded reward offer to the system user based on information entered through the merchant interface;
receiving notification of reward redemption of the merchant funded reward offer; and
updating the personalized introductory account page to reflect an updated number of rewards points.

27. The method of claim 26, further comprising providing multiple interactive rewards pages including rewards for purchase with rewards points.

28. The method of claim 26, wherein the multiple interactive rewards pages further comprise at least a reward description and one additional link containing reward information specific to the reward displayed.

29. The method of claim 26, further comprising accessing stored information to determine characteristics of the system user including at least one of location and prior purchases and personalizing the offer upon access to the introductory account page.

30. The method of claim 29, further comprising determining a time of day and tailoring the offer based on the time of day.
